(19) United States
(12) Patent Application Publication
(10) Pub. No.: US 2011/0200742 A1
(43) Pub. Date: Aug. 18, 2011

(54) DRYING METHOD AND DRYING DEVICE

(75) Inventor: Masataka Ikeda, Osaka (JP)

(73) Assignee: SHARP KABUSHIKI KAISHA, Osaka-shi, Osaka (JP)

(21) Appl. No.: 13/124,567

(22) PCT Filed: Aug. 17, 2009
(86) PCT No.: PCT/JP2009/064387

§ 371 Date: May 6, 2011

(30) Foreign Application Priority Data
Oct. 16, 2008 (JP) 2008-266968

(51) Int. Cl. B05D 5/12; F26B 25/06

(52) U.S. Cl. 427/101; 34/218

(57) ABSTRACT

A drying method in which a substrate on which a coating liquid such as a resist liquid containing a volatile solvent is applied is dried under a reduced pressure in an airtight container, and an inert gas is then supplied in the container, so that flows do not concentrate and accumulate in the center portion includes placing the substrate in the container, reducing pressure in the container by exhausting air through an exhaust channel using an exhaust mechanism and volatizing the solvent, and returning the container to atmospheric pressure by supplying an inert gas through a supply channel using a supply mechanism after the reducing step. The supply mechanism includes long purge nozzles ejecting the gas inside the container and spaced from and parallel to two opposed substrate edges. The returning step is performed by the nozzles ejecting the gas toward inside walls of the container opposite to the substrate.

### TECHNICAL FIELD

The present invention relates to a drying method and a drying device for drying a coating liquid such as a resist liquid that is applied on a square or rectangular substrate such as a glass substrate that is used in a liquid crystal display panel.

### BACKGROUND ART

In recent years, a liquid crystal display panel is widely used as a display unit of a household electrical appliance such as a personal computer and a television. The liquid crystal display panel includes a pair of glass substrates that are a thin film transistor (TFT) array substrate and a color filter (CF) substrate. The glass substrates are opposed parallel to each other leaving a given gap therebetween, and liquid crystals are filled between the glass substrates. The TFT array substrate has a matrix arrangement of a plurality of pixel electrodes, and the CF substrate has a common electrode that covers almost all over the surface of the CF substrate. Alignment of the liquid crystals is controlled by changing voltages that are applied between the electrodes.

The TFT array substrate of the liquid crystal display panel is generally manufactured by performing photolithography a plurality of times that includes forming a film on the substrate, forming a resist film, exposing the resist film, developing the resist film, etching, and stripping off the resist film.

To be specific, in order to provide an electric circuit including TFTs on the substrate, a metal film is formed on the substrate and is subjected to etching into a given pattern, so that a given electric circuit is formed. A resist that is a photosensitive resin is used for a mask for the etching, and the resist film is stripped off and removed after the etching.

In the formation of the resist film by photolithography, a resist applying step, a resist drying step, and a resist baking step are performed.

In the resist applying step, a resist liquid is applied to the entire surface of the substrate by spin coating or slit coating. In the resist drying step prior to the resist baking step, the resist liquid is dried to volatilize to a given degree a solvent such as a thinner that is contained in the resist liquid applied on the substrate.

In the resist baking step prior to the resist exposing step, the resist liquid is heated to enhance adhesion of the resist liquid to the substrate, so that an altered layer (hard layer) is formed at the surface of the resist liquid, and a resist film that is suitable for the exposure is formed on the substrate.

In general, the resist drying step after the resist applying step is performed such that the substrate on which the resist liquid is applied is put in an airtight container, air is exhausted from the airtight container to reduce a pressure in the airtight container, the solvent in the resist liquid is volatilized to dry the resist liquid, the airtight container is returned to an atmospheric pressure, and the substrate is taken out from the airtight container.

Conventionally, a drying device disclosed in Patent Literature 1 is used, for example, as the drying device for drying the resist liquid that is applied to the substrate. FIG. 9 is a cross-sectional side view of the conventional drying device. FIG. 10 is a cross-sectional top view of the conventional drying device.

As shown in FIGS. 9 and 10, a drying device 101 includes an airtight container 102 that incorporates a rest 103 on which a rectangular substrate 30 is placed. An air exhaust pipe P1 arranged to reduce a pressure in the airtight container 102 is connected to the airtight container 102 through an air exhaust channel 104. A gas supplying pump P2 arranged to supply an inert gas such as nitrogen in the airtight container 102 so as to return the airtight container 102 to an atmospheric pressure is connected to the airtight container 102 through gas supply channels 105.

The gas supply channels 105 are connected to purge nozzles 106 inside the airtight container 102, and the inert gas is ejected from the purge nozzles 106.

As shown in FIG. 10, the purge nozzles 106 are hollow tubes having a cylindrical shape and having a length almost equal to the length of shorter edges 30a of the substrate 30, and are spaced from the shorter edges 30a of the substrate 30. As shown in FIG. 11, a plurality of gas ejection holes 106a are provided in the circumference of each purge nozzle 106, and the inert gas is ejected through the circumference of the purge nozzle 106.

As shown in FIGS. 9 and 10, the inert gas ejected through the plurality of gas ejection holes in the circumferences of the purge nozzles 106 is formed into flows 107 that head for the substrate 30 directly from the purge nozzles 106 and flows 108 that once impinge on inside walls 102a of the airtight container 102 and are reflected from the inside walls 102a to head for the substrate 30. When the airtight container 102 is filled up with the inert gas of both of the flows 107 and 108, the airtight container 102 is returned to the atmospheric pressure.

In general, when the airtight container 102 is returned from the reduced pressure to the atmospheric pressure by the inert gas ejected from the purge nozzles 106, a nearly adiabatically expanded state is brought about in the airtight container 102. Therefore, the temperature of the inert gas in the airtight container 102 rises, and heat from the inert gas is applied to a resist liquid 40 on the substrate 30. No problem arises if heat from the inert gas is uniformly applied to the entire surface of the resist liquid 40. However, if heat from the inert gas is not uniformly applied to the surface of the resist liquid 40, an irregularity could occur in a dry condition of the resist liquid 40 (hereinafter referred to as a drying irregularity).

### CITATION LIST

### Patent Literature

Patent Literature 1: JP 2008-124366 A

### SUMMARY OF INVENTION

### Solution to Problem

However, in recent years, the substrate 30 that is used in a planar display panel such as a liquid crystal display panel has been increasing in size (8^{th} generation: 2160 mm by 2460 mm). Therefore, if the inert gas is introduced into the airtight container 102 using the purge nozzles 106 that eject the inert gas through their circumferences, the flows 107 and 108 of the inert gas become irregular as shown in FIGS. 9 and 10 and concentrate in the center portion of the substrate 30, which causes accumulation of the inert gas with heat in the center portion of the substrate 30.

The accumulation of the inert gas with heat in the center portion of the substrate 30 causes excessive drying of the resist liquid 40 in the center portion of the substrate 30 as compared to drying of the resist liquid 40 in the peripheral portion. As a result, a drying irregularity 40a having a substantially oval shape occurs in the center portion of the resist liquid 40 on the substrate 30.

The resist liquid 40 in the portion where the drying irregularity 40a occurs has lowered exposure sensitivity, which makes a pattern of a resist film after resist exposure and resist development have distortion or film residues. If etching is performed by using such a resist film as a mask, a short circuit occurs between adjacent pixel electrodes that are formed at the portion where the drying irregularity 40a occurs.

An object of the present invention is to overcome the problems described above and to provide a drying method and a drying device in which a substrate to which a coating liquid such as a resist liquid containing a volatile solvent is dried under a reduced pressure in an airtight container, and an inert gas is then supplied in the airtight container so as to return the airtight container to an atmospheric pressure, so that flows of the supplied inert gas are prevented from concentrating and accumulating in the center portion of the substrate.

### Solution to Problem

Preferred embodiments of the present invention provide a drying method for drying a coating liquid containing a solvent that is applied on a substantially square substrate that includes a placing step of placing in an airtight container the substrate on which the coating liquid containing the solvent is applied, a pressure reducing step of reducing a pressure in the airtight container by exhausting air from the airtight container through an air exhaust channel using an air exhaust mechanism and volatizing the solvent in the coating liquid that is applied on the substrate, and a pressure returning step of returning the airtight container to an atmospheric pressure by supplying an inert gas in the airtight container through a gas supply channel using a gas supply mechanism after the pressure reducing step, wherein the gas supply mechanism includes long purge nozzles that are arranged to eject the inert gas inside the airtight container, are spaced from two opposed edges of the substrate, and are substantially parallel to the opposed edges, and the pressure returning step is performed by the purge nozzles that are arranged to eject the inert gas toward inside walls of the airtight container that are opposite to the substrate.

Preferred embodiments of the present invention also provide a drying device for drying a coating liquid containing a solvent that is applied on a substantially square substrate that includes an airtight container that incorporate a rest on which the substrate is placed, an air exhaust mechanism that is connected to the airtight container through an air exhaust channel and is arranged to reduce a pressure in the airtight container so as to volatize the solvent in the coating liquid that is applied on the substrate, and a gas supply mechanism that is connected to the airtight container through a gas supply channel and is arranged to supply an inert gas in the airtight container so as to return the airtight container to an atmospheric pressure, wherein the gas supply mechanism comprises long purge nozzles that are arranged to eject the inert gas inside the airtight container, are spaced from two opposed edges of the substrates, and are substantially parallel to the opposed edges, and the purge nozzles are arranged to eject the inert gas toward inside walls of the airtight container that are opposite to the substrate.

In the drying method and the drying device having the above configurations, the purge nozzles arranged to eject the inert gas inside the airtight container so as to return the airtight container from the reduced pressure to the atmospheric pressure are spaced from the opposed edges of the substrates and are substantially parallel to the opposed edges, and the purge nozzles are arranged to eject the inert gas toward the inside walls of the airtight container that are opposite to the substrate. Therefore, all of the inert gas ejected from the purge nozzles is formed into indirect flows that once impinge on the inside walls of the airtight container and are reflected from the inside walls to head for the substrate, which prevents concentration and accumulation of the inert gas that are caused by both of direct flows that head for the substrate directly from the purge nozzles and indirect flows that once impinge on the inside walls of the airtight container and are reflected from the inside walls to head for the substrate.

Thus, excessive drying of the coating liquid in the center portion of the substrate as compared to the coating liquid in the other portion is prevented, which brings about a uniform drying state on the entire surface of the coating liquid.

It is preferable that flow regulating members that have a substantially arc shape in cross section and are arranged to control flows of the inert gas ejected from the purge nozzles toward the inside walls of the airtight container to head for the substrate are provided between the purge nozzles and the inside walls of the airtight container. With this configuration, all of the inert gas ejected from the purge nozzles is formed into flows that once impinge on the flow regulating members and are reflected from the flow regulating members to head for the substrate, and the substantially arc shape of the flow regulating members makes the flows uniform.

It is also preferable that flow regulating portions that have a substantially arc shape in cross section and are arranged to control flows of the inert gas ejected from the purge nozzles toward the inside walls of the airtight container to head for the substrate are provided to the inside walls of the airtight container. Also with this configuration, all of the inert gas ejected from the purge nozzles is formed into flows that once impinge on the flow regulating portions and are reflected from the flow regulating portions to head for the substrate, and the substantially arc shape of the flow regulating portions makes the flows uniform.

It is preferable that the purge nozzles include gas ejection holes that have a slit shape along a long direction of the purge nozzles. With this configuration, the flows of the inert gas ejected from the purge nozzles can be made uniform along the long direction of the purge nozzles.

### Advantageous Effects of Invention

In the drying method and the drying device having the above configurations, the purge nozzles are arranged to eject the inert gas toward the inside walls of the airtight container that are opposite to the substrate at the time of returning the airtight container to the atmospheric pressure. Therefore, all of the inert gas ejected from the purge nozzles is formed into the indirect flows that once impinge on the inside walls of the airtight container and are reflected from the inside walls to head for the substrate, which prevents concentration and accumulation of the inert gas in the center portion of the substrate that are caused by the direct flows that head for the substrate directly from the purge nozzles and the indirect flows that once impinge on the inside walls of the airtight container and are reflected from the inside walls to head for the substrate. Accordingly, the occurrence of the drying irregularity described above can be prevented, and if the coating liquid is a photosensitive liquid, a pattern of a resist film after resist exposure and resist development has no distortion or film residues.

### BRIEF DESCRIPTION OF DRAWINGS

FIG. 1 is a cross-sectional side view showing a drying device according to a first preferred embodiment of the present invention.

FIG. 2 is a cross-sectional top view of the drying device shown in FIG. 1.

FIG. 3 is an external perspective view of a purge nozzle of the drying device shown in FIG. 1.

FIG. 4 is a cross-sectional side view showing a drying device according to a second preferred embodiment of the present invention.

FIG. 5 is a cross-sectional top view of the drying device shown in FIG. 4.

FIG. 6 is a cross-sectional side view showing a drying device according to a third preferred embodiment of the present invention.

FIG. 7 is a cross-sectional top view of the drying device shown in FIG. 6.

FIG. 8A is a view showing a modified example of the purge nozzle, and FIG. 8B is a view showing a modified example of a flow regulating member.

FIG. 9 is a cross-sectional side view of a conventionally used drying device.

FIG. 10 is a cross-sectional top view of the drying device shown in FIG. 9.

FIG. 11 is an external perspective view of a purge nozzle of the drying device shown in FIG. 9.

### DESCRIPTION OF EMBODIMENTS

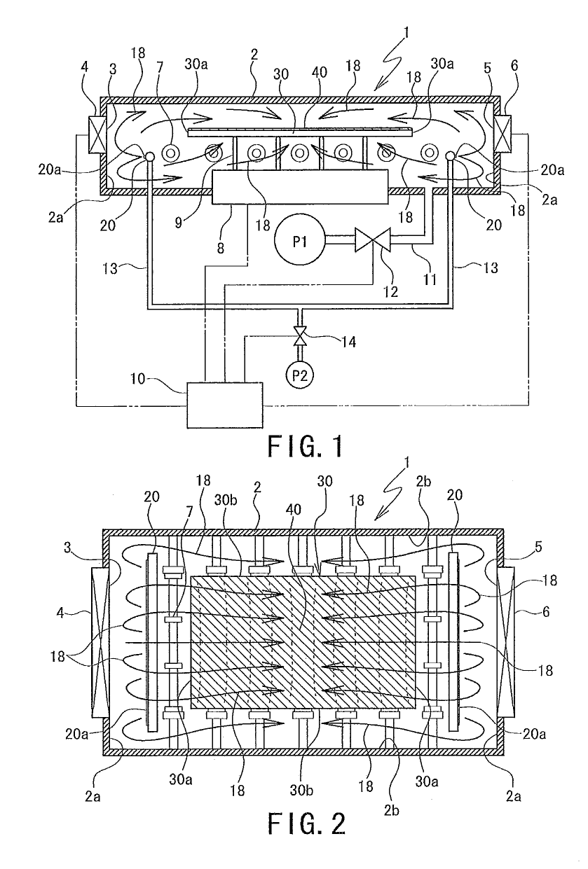

A detailed description of a drying method and a drying device according to preferred embodiments of the present invention will now be provided with reference to the accompanying drawings. FIG. 1 is a cross-sectional side view showing a schematic configuration of a drying device 1 according to a first preferred embodiment of the present invention. FIG. 2 is a cross-sectional top view of the drying device 1.

As shown in FIGS. 1 and 2, the drying device 1 includes an airtight container 2 the inside of which can be kept in an airtight state. A pressure in the airtight container 2 can be reduced to a vacuum degree of about 10 to 50 Pa by an air exhaust pump P1.

The airtight container 2 has a flat rectangular box shape and has a space in which the substrate 30 can be horizontally accommodated. In the preferred embodiments of the present invention, the substrate 30 is a rectangular planer substrate that has shorter edges 30a opposed parallel to each other and longer edges 30b opposed parallel to each other. For example, a substrate for a liquid crystal display panel is used as the substrate 30.

A resist liquid 40 is applied in advance to the top surface of the substrate 30 using a resist application device (not shown). The resist liquid 40 contains a solvent such as a volatile thinner. Reducing the pressure in the airtight container 2 and subjecting the resist liquid 40 to the reduced pressure during a given period of time can volatize the solvent and dry the resist liquid 40 moderately.

As shown in FIGS. 1 and 2, a substrate inlet 3 through which the substrate 30 is taken in the airtight container 2 and a gate valve 4 arranged to open and close the substrate inlet 3 are provided to the left side wall of the airtight container 2. In addition, a substrate outlet 5 through which the substrate 30 is taken out of the airtight container 2 and a gate valve 6 arranged to open and close the substrate outlet 5 are provided to the right side wall of the airtight container 2. Opening and closing of the gate valves 4 and 6 are controlled by a control unit 10. The substrate inlet 3 and the substrate outlet 5 are opposed to each other, and a substrate carrying path through which the substrate 30 is horizontally carried is provided between the substrate inlet 3 and the substrate outlet 5.

A plurality of substrate carrying rollers 7 are provided at regular intervals along the carrying direction of the substrate 30 in the substrate carrying path between the substrate inlet 3 and the substrate outlet 5. Each substrate carrying roller 7 is rotated by a roller rotation driving unit (not shown) that is provided outside the airtight container 2.

A substrate rest 8 arranged to horizontally support the substrate 30 and lift up and bring down the substrate 30 is provided inside the airtight container 2. A number of lift pins 9 are vertically provided to the substrate rest 8. The lift pins 9 are moved upward and downward on the substrate rest 8 by a pin up-and-down driving unit (not shown) that is provided inside or below the substrate rest 8. The control unit 10 controls the lift pins 9 so that the lift pins 9 are moved upward and downward between an upper position at which the top ends of the lift pins 9 are positioned higher than the substrate carrying path and a lower position at which the top ends of the lift pins 9 are positioned lower than the substrate carrying path.

The substrate 30 that is taken in the airtight container 2 through the substrate inlet 3 is placed on the substrate carrying rollers 7 and is carried to a position above the substrate rest 8, where the carriage of the substrate 30 is stopped, and the lift pins 9 of the substrate rest 8 are moved upward so as to lift up the substrate 30 to a given height above the substrate carrying rollers 7. After a pressure reducing step and a pressure returning step of the airtight container 2 that are to be described later are finished, the lift pins 9 are moved downward to put the substrate 30 again on the substrate carrying rollers 7, and the substrate 30 is carried by the substrate carrying rollers 7 to be taken out of the airtight container 2 through the substrate outlet 5.

An air exhaust channel 11 arranged to connect the inside of the airtight chamber 2 and the air exhaust pump P1 is preferably connected to the bottom of the airtight container 2. An air exhaust valve 12 is provided to the air exhaust channel 11, and opening and closing of the air exhaust valve 12 are executed by the control unit 10. Purge nozzles 20 are provided inside the airtight container 2 and are connected to a gas supply pump P2 through gas supply channels 13. A gas supply valve 14 is provided to the gas supply channels 13, and opening and closing of the gas supply valve 14 are executed by the control unit 10. The gas supply pump P2 supplies an inert gas such as nitrogen to the purge nozzles 20 through the gas supply channels 13. When the inert gas supplied from the gas supply pump P2 is ejected from the purge nozzles 20, the airtight container 2 is filled up with the inert gas.

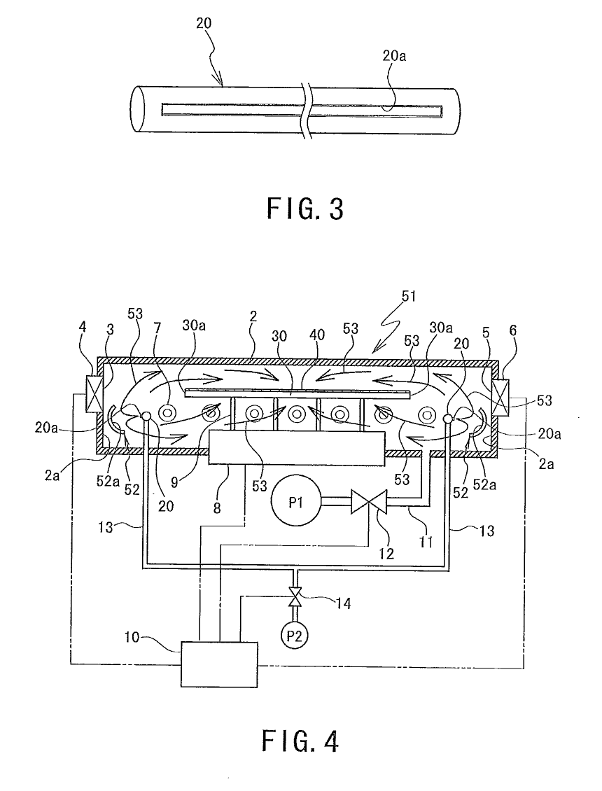

As shown in FIGS. 2 and 3, the purge nozzles 20 are hollow tubes having a cylindrical shape and having a length almost equal to the length of the shorter edges 30a of the substrate 30. The purge nozzles 20 are spaced from the shorter edges 30a on the both sides of the substrate 30. The purge nozzles 20 are located at both end portions inside the airtight container 2, i.e., at positions that are close to the substrate inlet 3 or the substrate outlet 5 and are lower than the substrate carrying path. The purge nozzles 20 extend along the shorter edges 30a of the substrate 30.

As shown in FIG. 3, each purge nozzle 20 includes a gas ejection hole 20a having a slit shape along the long direction of the purge nozzle 20. The slit shape of the gas ejection hole 20a makes the quantity of flow of the ejected inert gas uniform along the long direction of the purge nozzle 20. As shown in FIGS. 1 and 2, the gas ejection holes 20a of the purge nozzles 20 that are spaced from the shorter edges 30a on the both sides of the substrate 30 face inside walls 2a on the both sides of the airtight container 2.

Next, a description of the effect of the drying device 1 according to the first preferred embodiment of the present invention will be provided. First, the substrate 30 on which the resist liquid 40 is applied by a resist application device (not shown) is taken in the airtight container 2 through the substrate inlet 3 that is being opened by operation of the gate valve 4, is placed on the substrate carrying rollers 7, and is moved rightward by rotation of the substrate carrying rollers 7.

All of the lift pins 9 are brought into a standby state such that the top ends of the lift pins 9 are positioned lower than the substrate carrying path. When the substrate 30 reaches a given substantially center position in the airtight container 2, rotation of the substrate carrying rollers 7 is stopped. Then, the gate valve 4 is operated to close the substrate inlet 3 that has been opened so that the airtight container 2 is closed in an airtight state.

Then, the lift pins 9 of the substrate rest 8 are moved upward so that the top ends of the lift pins 9 are positioned higher than the substrate carrying path. The upward movement of the lift pins 9 makes the substrate 30 on the substrate carrying rollers 7 placed on the top ends of the lift pins 9 with the substrate 30 kept horizontal, and lifts up the substrate 30 to a given position above the substrate carrying rollers 7.

Then, the air exhaust pump P1 is operated to open the air exhaust valve 12, and air is exhausted from the airtight container 2 to reduce the pressure in the airtight container 2 to a given vacuum degree. Accordingly, the substrate 30 is subjected to the given reduced pressure in the airtight container 2. When the pressure in the airtight container 2 is reduced and the substrate 30 is exposed to the reduced pressure, the volatile solvent such as a thinner contained in the resist liquid 40 is volatized, and the resist liquid 40 applied on the substrate 30 is dried moderately at a normal temperature.

After a certain period of time, the air exhaust valve 12 is closed to stop the air exhaust by the air exhaust pump P1, and the pressure reducing step is finished. Then, the pressure returning step for returning the airtight container 2 to an atmospheric pressure is performed such that the gas supply valve 14 is opened to supply the inert gas in the airtight container 2 under the reduced pressure from the gas supply pump P2 through the gas supply channel 13 and the purge nozzles 20.

In the pressure returning step, a nearly adiabatically expanded state is brought about in the airtight container 2 by returning the airtight container 2 from the reduced pressure to the atmospheric pressure with the airtight container 2 being closed. Therefore, the temperature of the inert gas supplied into the airtight container 2 rises, and heat from the inert gas is applied to the resist liquid 40 on the substrate 30.

The inert gas ejected through the slit shaped gas ejection holes 20a of the purge nozzles 20 in the pressure returning step is formed into indirect flows 18 that once impinge on the inside walls 2a on the both sides of the airtight container 2 and are reflected from the inside walls 2a to head for the substrate 30.

Because the purge nozzles 20 are spaced from the opposed shorter edges 30a of the substrate 30, are substantially parallel to the shorter edges 30a, and eject the inert gas toward the inside walls 2a on the both sides of the airtight container 2 that are opposite to the substrate 30, all of the inert gas ejected from the purge nozzles 20 is formed into the flows 18 that once impinge on the inside walls 2a on the both sides of the airtight container 2 and are reflected from the inside walls 2a to head for the substrate 30, which prevents the flows 18 from becoming irregular.

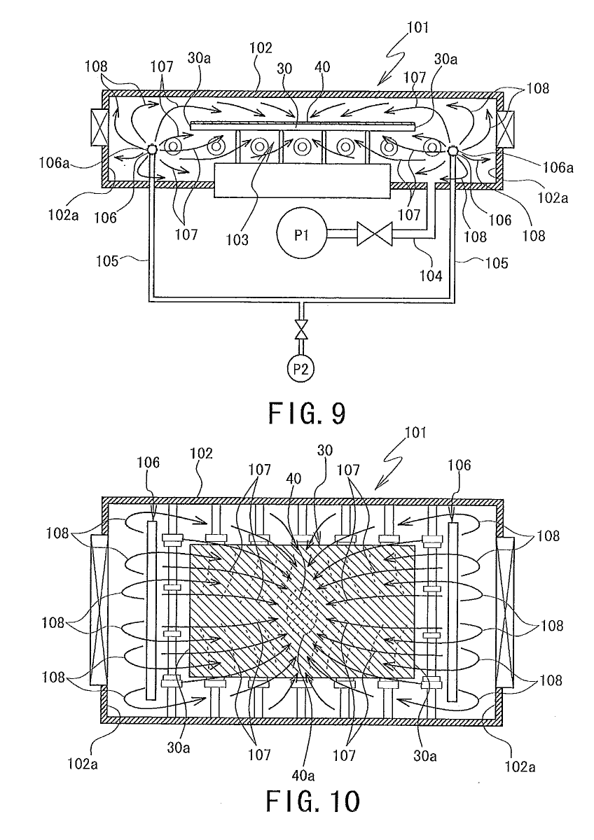

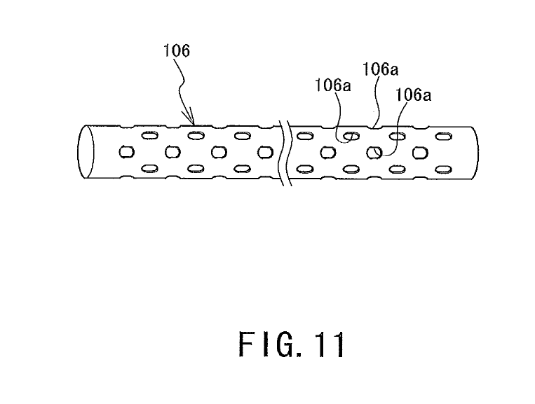

The problem of the conventional drying device shown in FIGS. 9 and 10 that the inert gas with heat is concentrated and accumulated in the center portion of the substrate 30 due to both of the direct flows 107 that head for the substrate 30 directly from the purge nozzles 106 and the indirect flows 108 that once impinge on the inside walls of the airtight container and are reflected from the inside walls to head for the substrate 30 is prevented.

In other words, in the pressure returning step of the drying device 1, heat from the inert gas is uniformly applied to the entire surface of the resist liquid 40 by the uniform flows 18 of the inert gas that once impinge on the inside walls 2a on the both sides of the airtight container 2 and are reflected from the inside walls 2a to head for the substrate 30. Thus, the drying irregularity 40a of the conventional drying device does not occur in the resist liquid 40.

Therefore, excessive drying of the resist liquid 40 in the center portion of the substrate 30 as compared to the resist liquid 40 in the other portion is prevented, which can bring about a uniform drying state on the entire surface of the resist liquid 40. Because the drying irregularity 40a of the conventional drying device does not occur in the resist liquid 40 in the pressure returning step of the drying device 1, the resist film after resist exposure and resist development is prevented from having distortion or film residues.

Because the gas ejection holes 20a of the purge nozzles 20 have the slit shape along the long direction of the purge nozzles 20, the quantity of flow of the ejected inert gas is made uniform in the long direction of the purge nozzles 20, and accordingly, the flows 18 that head for the substrate 30 can be made uniform.

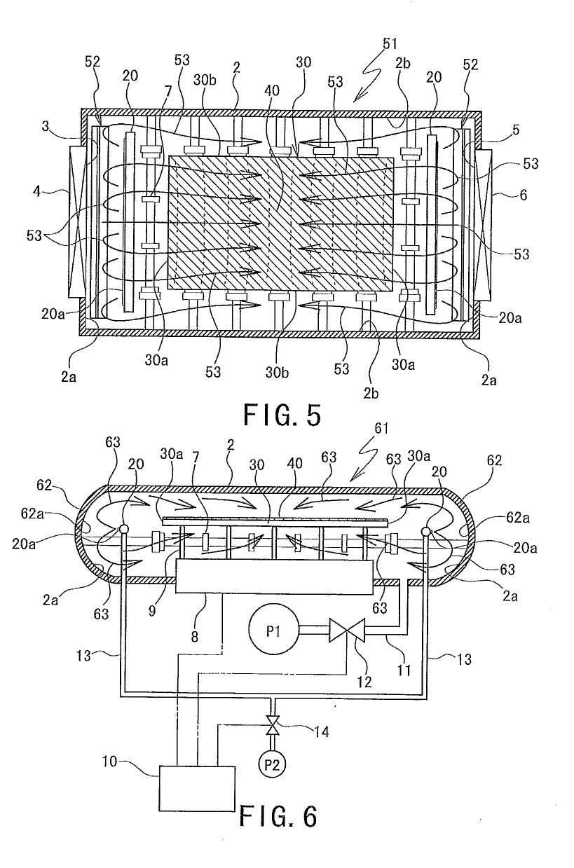

Next, a description of a second preferred embodiment of the present invention will be provided referring to FIGS. 4 and 5. FIG. 4 is a cross-sectional side view showing the schematic configuration of a drying device 51 according to the second preferred embodiment of the present invention. FIG. 5 is a cross-sectional top view of the drying device 51. Constituent elements that are the same as the constituent elements of the drying device according to the first preferred embodiment of the present invention are assigned the same numerals, and their descriptions are omitted. Descriptions of different constituent elements are mainly provided.

As shown in FIGS. 4 and 5, flow regulating members 52 having a substantially arc shape in cross section are provided between the purge nozzles 20 that eject the inert gas toward the inside walls 2a on the both sides of the airtight container 2 and the inside walls 2a. As shown in FIG. 5, the flow regulating members 52 have almost the same length as the purge nozzles 20 and are parallel to the purge nozzles 20. Arc portions 52a of the flow regulating members 52 are curved toward the inside walls 2a of the airtight container 2, and substantially center portions of the arc portions 52a face the slit shaped gas ejection holes 20a of the purge nozzles 20. The top ends of the flow regulating members 52 are positioned at a height that does not interrupt the substrate carrying path.

Also in the pressure returning step of the drying device 51 having the configuration described above, all of the inert gas ejected from the purge nozzles 20 is formed into flows 53 that once impinge on the flow regulating members 52 and are reflected from the flow regulating members 52 to smoothly head for the substrate 30. Owing to the flow regulating members 52 having the substantially arc shape in cross section in order to form the inert gas ejected from the purge nozzles 20 into the flows 53 that smoothly head for the substrate 30, the flows 53 are more effectively prevented from becoming irregular as compared to the case of forming the inert gas into the flows 18 that head for the substrate 30 by using the upright inside walls 2a of the airtight container 2 according to the first preferred embodiment of the present invention. Therefore, the flows 53 of the inert gas more smoothly head for the substrate 30.

Owing the uniform flows 53 of the inert gas, heat from the inert gas is uniformly applied to the entire surface of the resist liquid 40, which prevents the occurrence of the drying irregularity 40a of the conventional drying device in the resist liquid 40.

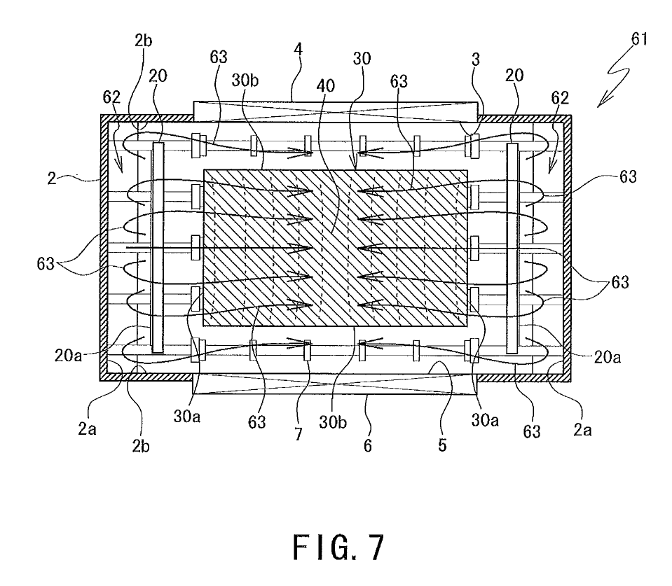

Next, a description of a third preferred embodiment of the present invention will be provided referring to FIGS. 6 and 7. FIG. 6 is a cross-sectional side view showing the schematic configuration of a drying device 61 according to the third preferred embodiment of the present invention. FIG. 7 is a cross-sectional top view of the drying device 61. Constituent elements that are the same as the constituent elements of the drying device according to the first preferred embodiment of the present invention are assigned the same numerals, and their descriptions are omitted. Descriptions of different constituent elements are mainly provided.

As shown in FIGS. 6 and 7, the drying device 61 includes the substrate inlet 3, the substrate outlet 5, and the gate valves 4 and 6 arranged to open and close the substrate inlet 3 and the substrate outlet 5 on inside walls 2b that are opposed to longer edges 30b of the substrate 30 that is accommodated in the airtight container 2, and the substrate carrying rollers 7 are provided between the substrate inlet 3 and the substrate outlet 5, so that the substrate carrying path is provided. The carrying direction of the substrate 30 with respect to the airtight container 2 of the drying device 61 is different from the carrying direction of the substrate 30 with respect to the airtight container 2 of the drying device 1.

Flow regulating portions 62 are provided to the inside walls 2a on the both sides of the airtight container 2 that face the shorter edges 30a of the substrate 30. The flow regulating portions 62 have an arc shape in cross section that is curved outward and are parallel to the purge nozzles 20. Substantially center portions of arc portions 62a of the flow regulating portions 62 face the slit shaped gas ejection holes 20a of the purge nozzles 20.

Also in the pressure returning step of the drying device 61 having the configuration described above, all of the inert gas ejected from the purge nozzles 20 is smoothly formed into flows 63 that once impinge on the flow regulating portions 62 and are reflected from the flow regulating portions 62 to head for the substrate 30. Owing to the flow regulating portions 62 having the arc shape in cross section in order to smoothly form the inert gas ejected from the purge nozzles 20 into the flows 63 that head for the substrate 30, the flows 63 are more effectively prevented from becoming irregular as compared to the case of forming the inert gas into the flows 18 that head for the substrate 30 by the upright inside walls 2a of the airtight container 2 according to the first preferred embodiment of the present invention. Therefore, the flows 63 of the inert gas more smoothly head for the substrate 30.

Owing the uniform flows 63 of the inert gas, heat from the inert gas is uniformly applied to the entire surface of the resist liquid 40, which prevents the occurrence of the drying irregularity 40a of the conventional drying device in the resist liquid 40.

While preferred embodiments of the present invention have been described above, it is to be understood that variations and modifications will be apparent to those skilled in the art without departing from the scope and spirit of the present invention.

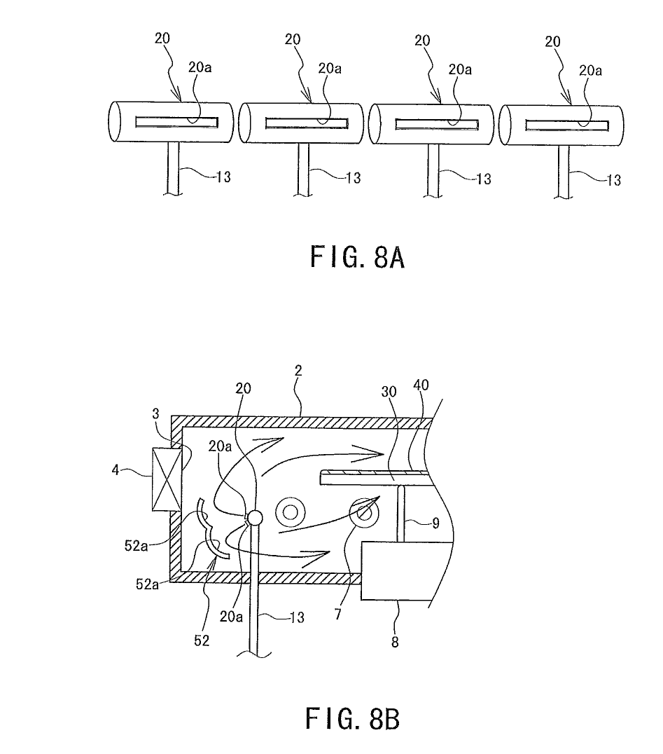

For example, it is preferable as shown in FIG. 8A that the purge nozzle 20 is divided along the long direction, and gas supply channels 13 are connected to respective ones of the divided purge nozzles 20. It is also preferable as shown in FIG. 8B that slits 20a are arranged one above the other on one side of the purge nozzle 20, and the inert gas ejected through the slits 20a is formed into flows that head for the substrate 30 by a flow regulating member 52 that include two arc portions 52a connected vertically.

1. A drying method for drying a coating liquid containing a solvent that is applied on a substantially square substrate, the method comprising:
a placing step of placing in an airtight container the substrate on which the coating liquid containing the solvent is applied;
a pressure reducing step of reducing a pressure in the airtight container by exhausting air from the airtight container through an air exhaust channel using an air exhaust mechanism and volatizing the solvent in the coating liquid that is applied on the substrate; and
a pressure returning step of returning the airtight container to an atmospheric pressure by supplying an inert gas in the airtight container through a gas supply channel using a gas supply mechanism after the pressure reducing step,
wherein the gas supply mechanism includes long purge nozzles that are arranged to eject the inert gas inside the airtight container, are spaced from two opposed edges of the substrate, and are substantially parallel to the opposed edges, and
the pressure returning step is performed by the purge nozzles that are arranged to eject the inert gas toward inside walls of the airtight container that are opposite to the substrate.

2. The drying method according to claim 1, wherein
flow regulating members that have a substantially arc shape in cross section and are arranged to control flows of the inert gas ejected from the purge nozzles toward the inside walls of the airtight container to head for the substrate are provided between the purge nozzles and the inside walls of the airtight container, and
the pressure returning step is performed by forming the inert gas into the flows that head for the substrate by the flow regulating members.

3. The drying method according to claim 1, wherein
flow regulating portions that have a substantially arc shape in cross section and are arranged to control flows of the inert gas ejected from the purge nozzles toward the inside walls of the airtight container to head for the substrate are provided to the inside walls of the airtight container, and
the pressure returning step is performed by forming the inert gas into the flows that head for the substrate by the flow regulating portions.

4. The drying method according to claim 1, wherein the pressure returning step is performed by using the purge nozzles that include gas ejection holes that have a slit shape along a long direction of the purge nozzles.

5. A drying device for drying a coating liquid containing a solvent that is applied on a substantially square substrate, the drying device comprising:
an airtight container that incorporate a rest on which the substrate is placed;
an air exhaust mechanism that is connected to the airtight container through an air exhaust channel and is arranged to reduce a pressure in the airtight container so as to volatize the solvent in the coating liquid that is applied on the substrate; and
a gas supply mechanism that is connected to the airtight container through a gas supply channel and is arranged to supply an inert gas in the airtight container so as to return the airtight container to an atmospheric pressure,
wherein the gas supply mechanism comprises long purge nozzles that are arranged to eject the inert gas inside the airtight container, are spaced from two opposed edges of the substrates, and are substantially parallel to the opposed edges, and
the purge nozzles are arranged to eject the inert gas toward inside walls of the airtight container that are opposite to the substrate.

6. The drying device according to claim 5, further comprising flow regulating members that have a substantially arc shape in cross section, are arranged to control flows of the inert gas ejected from the purge nozzles toward the inside walls of the airtight container to head for the substrate, and are provided between the purge nozzles and the inside walls of the airtight container.

7. The drying device according to claim 5, further comprising flow regulating portions that have a substantially arc shape in cross section, are arranged to control flows of the inert gas ejected from the purge nozzles toward the inside walls of the airtight container to head for the substrate, and are provided to the inside walls of the airtight container.

8. The drying device according to claim 5, wherein the purge nozzles comprise gas ejection holes that have a slit shape along a long direction of the purge nozzles.

9. The drying method according to claim 2, wherein the pressure returning step is performed by using the purge nozzles that include gas ejection holes that have a slit shape along a long direction of the purge nozzles.

10. The drying method according to claim 3, wherein the pressure returning step is performed by using the purge nozzles that include gas ejection holes that have a slit shape along a long direction of the purge nozzles.

11. The drying device according to claim 6, wherein the purge nozzles comprise gas ejection holes that have a slit shape along a long direction of the purge nozzles.

12. The drying device according to claim 7, wherein the purge nozzles comprise gas ejection holes that have a slit shape along a long direction of the purge nozzles.
